(19) United States
(12) Patent Application Publication
(10) Pub. No.: US 2015/0060579 A1
(43) Pub. Date: Mar. 5, 2015

(54) Electrostatic Spray System

(71) Applicant: Finishing Brands Holdings Inc., Minneapolis, MN (US)

(72) Inventors: Steven A. Myers, Scottsdale, AZ (US); Payton X. Cozart, Uniontown, OH (US); Kyle F.M. Miller, Temperance, MI (US)

(21) Appl. No.: 14/462,344

(22) Filed: Aug. 18, 2014

Related U.S. Application Data
(60) Provisional application No. 61/871,741, filed on Aug. 29, 2013.

(51) Int. Cl. B05B 5/04; B05B 5/03

(52) U.S. Cl. CPC B05B 5/0407; B05B 5/03
USPC 239/703

(57) ABSTRACT

A system including an electrostatic spray system, including a handheld spray coating device, a rotary atomizer coupled to the handheld spray coating device, wherein the rotary atomizer atomizes a liquid flowing through the handheld spray coating device, and an indirect charging device coupled to the handheld spray coating device, wherein the indirect charging device is configured to electrostatically charge the liquid exiting the rotary atomizer.

### CROSS-REFERENCE TO RELATED APPLICATION

This Application is a Non-Provisional Application and claims priority to U.S. Provisional Patent Application No. 61/871,741, entitled “Electrostatic Spray System”, filed Aug. 29, 2013, which is herein incorporated by reference.

### BACKGROUND

The invention relates generally to an electrostatic spray system.

Electrostatic tools spray electrically charged materials to more efficiently coat objects. For example, electrostatic tools may be used to paint objects. In operation, a grounded target attracts electrically charged materials sprayed from an electrostatic tool. As the electrically charged material contacts the grounded target, the material loses the electrical charge.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system including an electrostatic spray system, including a handheld spray coating device, a rotary atomizer coupled to the handheld spray coating device, wherein the rotary atomizer atomizes a liquid flowing through the handheld spray coating device, and an indirect charging device coupled to the handheld spray coating device, wherein the indirect charging device is configured to electrostatically charge the liquid exiting the rotary atomizer.

In another embodiment, a system including an indirect charging system configured to electrostatically charge a liquid sprayed from a handheld spray coating device with a rotary atomizer, wherein the indirect charging device system includes a non-conductive casing configured to couple to the handheld spray coating device, and a power supply coupled to the non-conductive casing, wherein the power supply enables electrostatic charging of the liquid passing through the non-conductive casing.

In another embodiment, a system including an electrostatic spray system, including a spray coating device, an atomizer coupled to the spray coating device, wherein the atomizer is configured to atomize a liquid flowing through the spray coating device, an indirect charging device, including a non-conductive casing downstream and radially offset from the atomizer, and a power supply coupled to the non-conductive casing, wherein the indirect charging device electrostatically charges the liquid exiting the atomizer.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional side view of an embodiment of a spray coating device;

FIG. 2 is a cross-sectional side view of an embodiment of an indirect charging device coupled to a rotary atomizer;

FIG. 3 is a cross-sectional side view of an embodiment of an indirect charging device;

FIG. 4 is a cross-sectional side view of an embodiment of an indirect charging device;

FIG. 5 is a cross-sectional side view of an embodiment of an indirect charging device;

FIG. 6 is a cross-sectional side view of an embodiment of an indirect charging device; and

FIG. 7 is a cross-sectional side view of an embodiment of an indirect charging device.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed to an electrostatic spray system that indirectly charges a fluid that is atomized and sprayed by a handheld spray gun. More specifically, the system includes an indirect charging device that electrically charges a fluid that is atomized by a rotary atomizer The indirect charging device may include a high voltage power supply, a conductive member (e.g., a wire), and a non-conductive casing member coupled to the rotary atomizer. In operation, the high voltage power supply supplies a high voltage current that flows through the conductive member attached to the non-conductive casing. As the high voltage current flows through the conductive member, the high voltage current produces a magnetic field enabling indirect electrical charging of the atomized fluid passing through the non-conductive casing. In one embodiment, the conductive member may couple to an end of the non-conductive casing to charge the atomized fluid as the atomized fluid exits the non-conductive casing. In some embodiments, the conductive member may wrap around an interior surface of the non-conductive housing charging the atomized fluid before the atomized fluid exits the non-conductive casing. In another embodiment, there may be multiple conductive members coupled to the power supply and that receive differing amounts of current and voltage. In still another embodiment, the indirect charging device may include a conductive casing coupled to the non-conductive casing and that receives high voltage current from the power supply to indirectly charge the fluid.

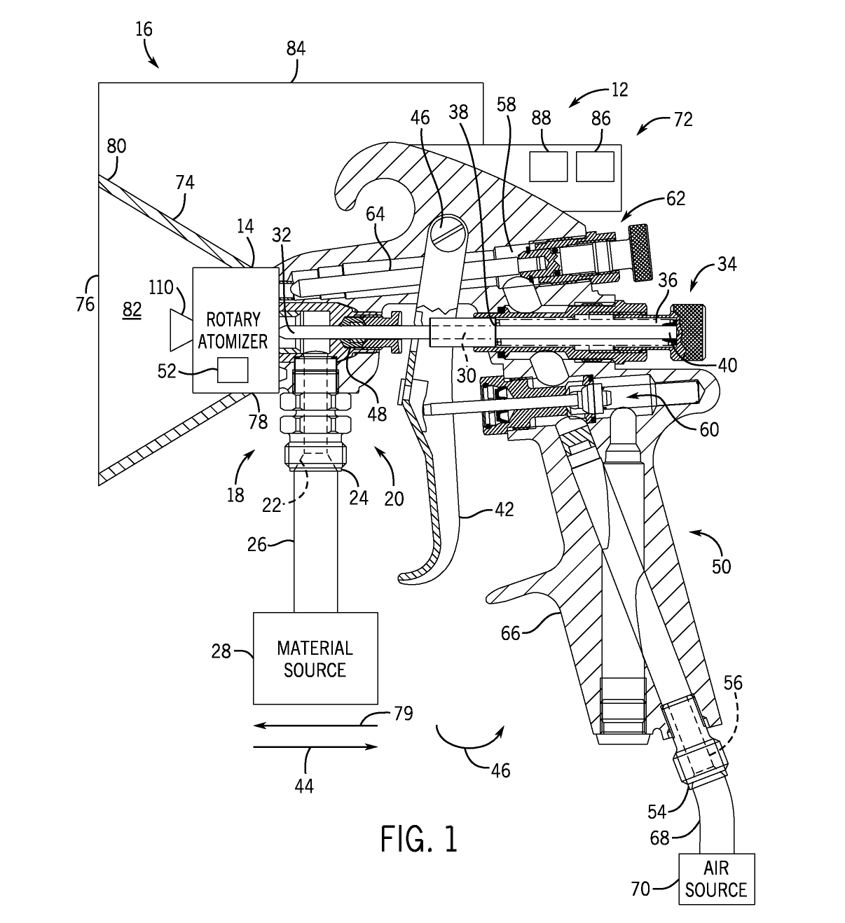

FIG. 1 is a cross-sectional side view illustrating an embodiment of an electrostatic spray system 10 that includes a handheld spray coating device 12 (e.g., a gun), a rotary atomizer 14, and an indirect charging device 16. As illustrated, the handheld spray coating device 12 includes a body 18 that enables the rotary atomizer 14 and the indirect charging device 16 to couple to the handheld spray coating device 12. In operation, the indirect charging device 16 enables electrostatic charging of a fluid (e.g., liquid coating material) that is atomized by the rotary atomizer 14 to facilitate spraying a target or object. In some embodiments, the indirect charging device 16 enables electrostatic charging when using spray formation mechanisms other than a rotary atomizer 14, such as an air cap that facilitates pneumatic atomization of the fluid (e.g., liquid coating material).

The body 18 of the spray coating device 12 includes a variety of controls and supply mechanisms for the rotary atomizer 14. As illustrated, the body 18 includes a fluid delivery assembly 20 having a fluid passage 22 extending from a fluid inlet coupling 24 through the rotary atomizer 14. The fluid inlet coupling 24 enables attachment of a conduit 26 that delivers liquid material from the material source 28 to the rotary atomizer 14, through the fluid passage 22. To control fluid flow to the rotary atomizer 14, the spray coating device 12 includes a fluid valve assembly 30. The fluid valve assembly 30 has a needle valve 32 extending movably through the body 18 between the rotary atomizer 14 and a valve adjuster 34. In certain embodiments, the valve adjuster 34 may be rotatably adjustable against a spring 36 disposed between a rear section 38 of the needle valve 32 and an internal portion 40 of the valve adjuster 34.

The needle valve 32 is also coupled to a trigger 42, such that the needle valve 32 may be moved inwardly, in direction 44 away from the rotary atomizer 14, as the trigger 42 is rotated in a counter clockwise direction 46 about a pivot joint 46. However, any suitable inwardly or outwardly openable valve assembly may be used within the scope of the present embodiments. As the needle valve 32 moves inwardly away from the rotary atomizer 14, the needle valve 32 unseats (i.e., opens) enabling fluid to flow through the fluid passage 22 and into the rotary atomizer 14. More specifically, in some embodiments, the fluid flowing through the fluid passage 22 may be pressure fed, so that when the needle valve 32 moves away from the fluid tip exit 30, the pressure induces the fluid to enter the rotary atomizer 14. In certain embodiments, the fluid valve assembly 30 may also include a variety of packing and seal assemblies, such as packing assembly 48, disposed between the needle valve 32 and the body 16.

An air supply assembly 50 is also disposed in the body 16 to facilitate atomization at the spray formation assembly 22. Specifically, the rotary atomizer 14 may include an air driven motor 52 that drives the rotary atomizer for atomization of the fluid. The illustrated air supply assembly 50 extends from an air inlet coupling 54 to the rotary atomizer 14 via air passages 56 and 58. The air supply assembly 50 also includes a variety of seal assemblies, air valve assemblies, and air valve adjusters to maintain and regulate the air pressure and flow through the spray coating device 12. For example, the illustrated air supply assembly 50 includes an air valve assembly 60 coupled to the trigger 42, such that rotation of the trigger 42 about the pivot joint 56, in direction 46, opens the air valve assembly 60 to allow airflow from the air passage 56 to the air passage 58. The air supply assembly 50 also includes an air valve adjustor 62 coupled to a needle 64, such that the needle 64 is movable via rotation of the air valve adjustor 62 to regulate the air flow to the air motor 52 within the rotary atomizer 14. As illustrated, the trigger 42 is coupled to both the fluid valve assembly 30 and the air valve assembly 60, such that the fluid and air simultaneously flow to the rotary atomizer 14 as the trigger 42 is pulled toward a handle 66 of the body 16. Once engaged, the spray coating device 12 produces an electrically charged atomized spray with a desired spray pattern and droplet distribution. As further illustrated, an air conduit 68 is coupled to the air inlet coupling 54 and the air source 70 enabling airflow from the air source 70 into the spray coating device 12 during operation.

As mentioned above, the handheld spray gun 12 includes an indirect charging device 16 that enables electrostatic charging of a fluid atomized by the rotary atomizer 14. The indirect charging device 16 includes a power supply 72, a non-conductive casing or wall 74, and a conductive member 76. As illustrated, the non-conductive casing or wall 74 (e.g., an annular wall, a conical wall, a curved annular wall, a diverging wall, or any combination thereof) attaches to the rotary atomizer 14 and forms a funnel with a first end 78, a second end 80, and a fluid passage 82 between the first end 78 and the second end 80. In some embodiments, the non-conductive casing 74 may be elliptically shaped, bell shaped, conical shaped, parabolically shaped, generally diverging, generally cylindrical, square, rectangular, etc. Moreover in some embodiments, the non-conductive casing 74 may be integrally coupled to the rotary atomizer 14. In operation, the rotary atomizer 14 atomizes the fluid that passes through the non-conductive casing 74 in direction 79. As the fluid passes through the non-conductive casing 74, a magnetic field created by a high voltage current carried in the conductive member 76 indirectly charges (i.e., ionizes) the fluid. The conductive member 76 electrically couples to the power supply 72 with the electric line 84. The power supply 72 generates the high voltage current with a power source 86 and a cascade voltage multiplier 88. In operation, the power source 86 provides the electric current, while the cascade voltage multiplier 88 increases the voltage.

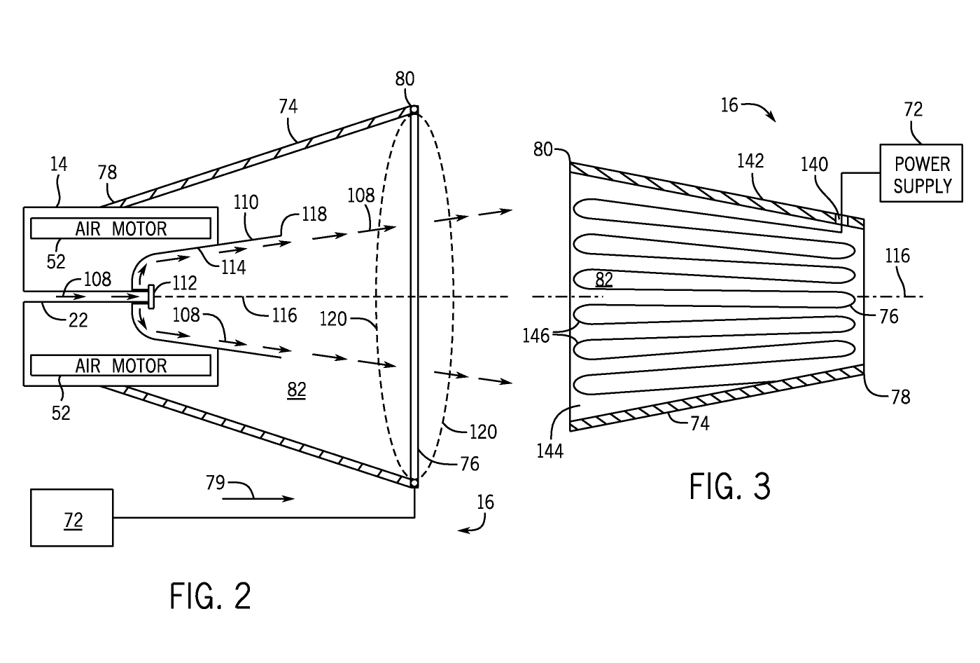

FIG. 2 is a cross-sectional side view of an embodiment of a rotary atomizer 14 surrounded by the non-conductive member 74. As explained above, the rotary atomizer 14 enables the spray coating device 12 to atomize a fluid 108 for spraying. In some embodiments, the rotary atomizer 14 may be a bell-shaped rotary atomizer that receives the fluid 108 from the fluid delivery assembly 20 through the fluid passage 22. As the fluid 108 flows through the fluid passage 22, the fluid 108 enters a rotary bell cup 110 where the fluid 108 contacts an impingement plate 112. The bell cup 110 may be a conical bell cup, a parabolic bell cup, a generally curved annular bell cup, or a diverging annular bell cup. The plate 112 redirects the fluid 108 radially outward and towards the interior surface 114 of the bell cup 110. As the bell cup 110 rotates about the axis 116, the fluid 108 flows along the interior surface 114 of the bell cup 110. For example, the centrifugal force of the rotating bell cup 110 forces the fluid to flow directly along the internal surface 114, in a downstream direction axially toward the edge 118. When the fluid 108 reaches the edge 118, (e.g., outer annular edge) the rotation of the bell cup 110 shears the fluid 108. In other words, the rotary atomizer 14 atomizes the fluid 108 as the fluid 108 shears off the edge 118 of the bell cup 110. After exiting the bell cup 110, the fluid 108 enters the fluid passage 82 in the non-conductive casing 74. As illustrated, the bell cup 110 is rotary and the non-conductive casing 74 is stationary and offset (e.g., radially offset) from the bell cup 110. As the fluid 108 passes through and exits the non-conductive casing 74, the fluid 108 is indirectly charged or ionized in a magnetic field 120. As explained above, the indirect charging device 16 forms the magnetic field 120 as high voltage current, supplied by the power supply 72, passes through the conductive member 76.

FIG. 3 is a cross-sectional side view of an embodiment of an indirect charging device 16. As illustrated, the indirect charging device 16 includes the power supply 72 that supplies a high voltage current to indirectly charge an atomized fluid. The power supply 72 couples to a conductive member 76 (e.g., a wire) that then carries the high voltage current in the indirect charging device 16. The conductive member 76 enters the non-conductive casing 74 through an aperture 140 in the side wall 142. After passing through the aperture 140, the conductive member 76 may couple to the interior surface 144 and wind back and forth between the first end 78 and the second end 80 along the fluid passage 82. In operation the conductive member 76 enables high voltage current from the power supply 72 to form a magnetic field that indirectly charges or ionizes the atomized fluid passing through the fluid passage 82. As illustrated, the conductive member 76 is generally parallel to the non-conductive member 74 as the conductive member 76 winds back and forth between the first end 78 and the second end 80. However in some embodiments, the conductive member 76 may not wind back and forth between the first end 78 and the second end 80, but instead wind back and forth a fraction of the distance between the first end 78 and the second end 80 (e.g., 10, 20, 30, 40, 50, 60, 70, 80, 90, 100 percent). In embodiments where the conductive member 76 winds back and forth a fraction of the distance between the first end 78 and the second end 80, the conductive member 76 may be closer to either the first end 76 or the second end 78. Furthermore, some embodiments may include different amounts of windings 146 within the non-conductive member 74. For example, some embodiments may include more windings 146, with correspondingly less space between the windings 146, while other embodiments have fewer windings 146 that are then spaced further apart.

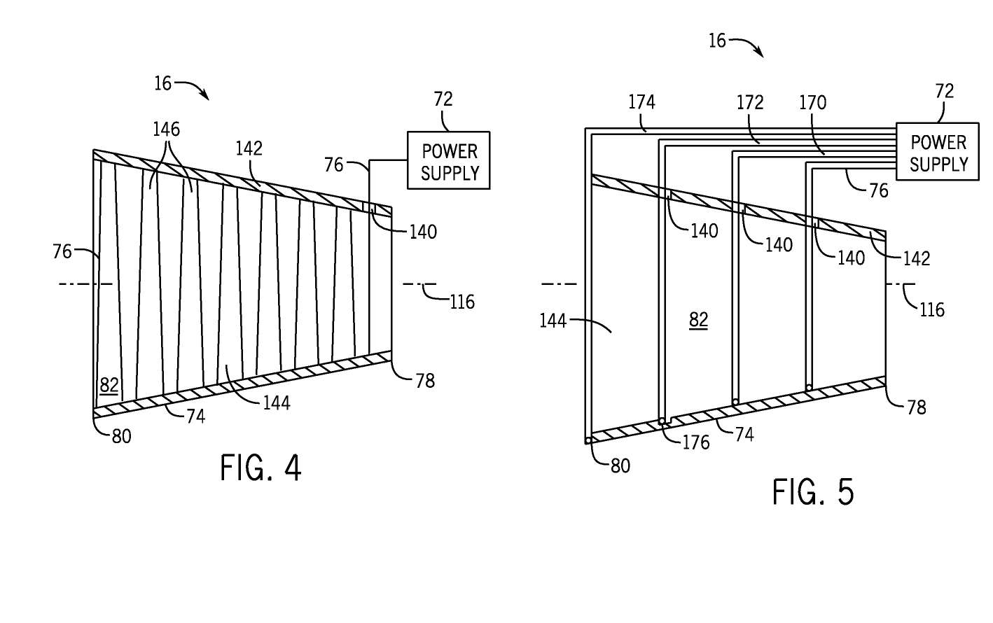

FIG. 4 is a cross-sectional side view of an embodiment of an indirect charging device 16. The indirect charging device 16 is similar to the indirect charging device shown in FIG. 3 and discussed above. However, the orientation of the conductive member 76 in the indirect charging device 16 of FIG. 4 is generally perpendicular to the non-conductive casing 74 (e.g., perpendicular or crosswise to axis 116). As illustrated, the conductive member 76 spirals crosswise (e.g., perpendicular to the axis 116) between the first end 78 and the second end 80 along the interior surface 144 of the non-conductive casing 74. However, in some embodiments, conductive member 76 may spiral a fraction of the distance between the first end 78 and the second end 80 (e.g., 10, 20, 30, 40, 50, 60, 70, 80, 90, 100 percent). In embodiments where the conductive member 76 spirals a fraction of the distance between the first end 78 and the second end 80, the conductive member 76 may be closer to either the first end 76 or the second end 78. Furthermore, in some embodiments the conductive member 76 may form a spiral that becomes more compact between the first end 78 and the second end 80 of the non-conductive casing 74. For example, the conductive member 76 may form a spiral that increases in density near the second end 80 of the non-conductive casing 74.

FIG. 5 is a cross-sectional side view of an embodiment of an indirect charging device 16. As illustrated, the indirect charging device 16 includes conductive members 76, 170, 172, and 174 (e.g., annular conductive members) that coupled to the power supply 72. Furthermore, each of the conductive members 76, 170, 172, and 174 couples to the non-conductive housing 74 enabling the indirect charging device 16 to form a magnetic field(s) that charge an atomized fluid passing through the fluid passage 82. In some embodiments, the indirect charging device 16 may include less than or more than four conductive elements (e.g., 1, 2, 3, 4, 5, 10, 15, 20 or more separate conductive elements). As illustrated, conductive members 76, 170, and 172 pass through the side wall 142 and couple to the interior surface 144 of the non-conductive casing 74, while the conductive member 174 couples to the second end 80 of the non-conductive casing 74. As illustrated, the conductive members 76, 170, 172, and 174 are approximately equal distant apart from one another along the length of the non-conductive casing 74. However, in some embodiments, the conductive members 76, 170, 172, and 174 may be closer together near the first end 78 or the second end 80. In other embodiments, the indirect charging device 16 may vary the spacing between the conductive members 76, 170, 172, and 174.

In operation, the indirect charging device 16 may use the conductive members 76, 170, 172, and 174 in different ways to indirectly charge the atomized fluid. For example, the power supply 72 may supply different amounts of current and voltage to each of the conductive members 76, 170, 172, and 174 (e.g., progressively increase, progressively decrease, or alternate current flow and voltage between the conductive members). The indirect charging device 16 may also enable a user to turn off some of the conductive members 76, 170, 172, and 174 depending on the application. Furthermore, in some embodiments, the 76, 170, 172, and 174 may be embedded in the interior surface 144 of the non-conductive casing 74. As illustrated, conductive member 172 embeds within a recess 176 (e.g., annular recess) in the non-conductive casing 74 reducing possible contact between the atomized fluid and the conductive member 172.

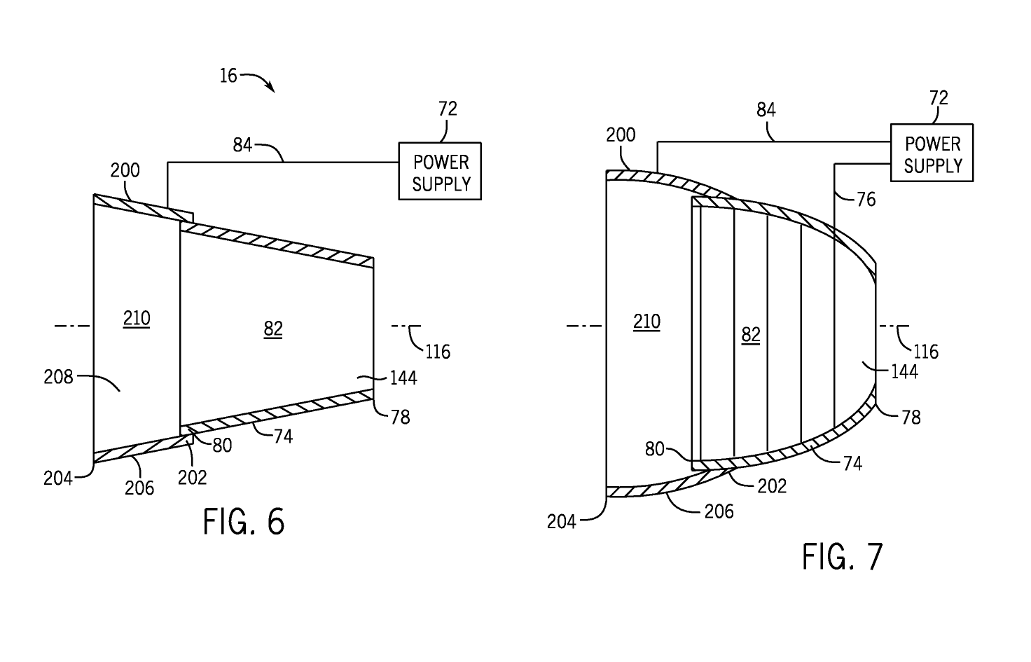

FIG. 6 is a cross-sectional side view of an embodiment of an indirect charging device 16 that includes a conductive casing 200 coupled to the non-conductive casing 74. The casings 74 and 200 may be conical casings, parabolic casings, cylindrical casings, diverging annular casings, or any combination thereof. The conductive casing 200 includes a first end 202, a second end 204, an exterior surface 206, an interior surface 208, and an aperture 210 between the first end 202 and the second end 204. As illustrated, the first end 202 of the conductive casing 200 couples to the second end 80 of the non-conductive casing 74. The coupling between the conductive casing 200 and the non-conductive casing 74 maybe a snap-fit connection, a friction fit connection, a threaded connection, or a bolted connection. The conductive casing 200 electrically couples to and receives high voltage current from the power supply 72 with the electric line 84. In operation, the power supply 72 supplies a high voltage current to the conductive casing 200 that indirectly charges the atomized fluid. More specifically, as high voltage electric current flows through the conductive casing 200 the high voltage current creates a magnetic field that indirectly charges/ionizes the atomized fluid passing through the aperture 210.

FIG. 7 is a cross-sectional side view of an embodiment of an indirect charging device 16 that includes a conductive casing 200 coupled to the non-conductive casing 74. As illustrated, the conductive casing 200 and the non-conductive casing 74 may have curved annular bell shapes. However, in some embodiments, the conductive casing 200 and/or the non-conductive casing 74 may have another shape (e.g., cylindrically shaped, parabolic shaped, elliptically shaped, square shaped, rectangular shaped, or a truncated conical shape). For example, the non-conductive casing 74 may be a truncated conical shape, while the conductive casing 200 is cylindrical, or vice versa. In the illustrated embodiment, the non-conductive casing 74 and the conductive casing 200 both define curved annular bell shapes.

As explained above, the first end 202 of the conductive casing 200 couples to the second end 80 of the non-conductive casing 74. The coupling between the conductive casing 200 and the non-conductive casing 74 maybe a snap-fit connection, a friction fit connection, a threaded connection, or a bolted connection. The conductive casing 200 electrically couples to and receives high voltage current from the power supply 72 with the electric line 84. In operation, the power supply 72 supplies a high voltage current to the conductive casing 200 that indirectly charges the atomized fluid. More specifically, as high voltage electric current flows through the conductive casing 200, the high voltage current creates a magnetic field that indirectly charges/ionizes the atomized fluid passing through the aperture 210. Furthermore, and as illustrated, the non-conductive casing 74 may include a conductive member 76 that couples to the power supply 72. The conductive member 76 enables high voltage current from the power supply 72 to form a magnetic field within the non-conductive casing 74 that indirectly charges or ionizes the atomized fluid passing through the fluid passage 82. The indirect charging device 16 may combine the conductive casing 200 with the conductive members 76 in different ways to indirectly charge the atomized fluid. For example, the power supply 72 may supply different amounts of current and voltage to the conductive casing 200 and the conductive member 76 (e.g., progressively increase, progressively decrease, or alternate current flow and voltage between the conductive members). The indirect charging device 16 may also enable a user to turn off the current flow to the conductive casing 200 or the conductive member 76 depending on the application.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an electrostatic spray system, comprising:
a handheld spray coating device;
a rotary atomizer coupled to the handheld spray coating device, wherein the rotary atomizer atomizes a liquid flowing through the handheld spray coating device; and
an indirect charging device coupled to the handheld spray coating device, wherein the indirect charging device is configured to electrostatically charge the liquid exiting the rotary atomizer.

2. The system of claim 1, wherein the indirect charging device comprises a non-conductive casing comprising an aperture with an interior surface between a first end and a second end.

3. The system of claim 2, wherein the non-conductive casing couples to the rotary atomizer at the first end.

4. The system of claim 2, wherein the indirect charging device comprises a power supply coupled to the non-conductive casing with a conductive member.

5. The system of claim 4, wherein the conductive member circumferentially couples to the non-conductive casing about the second end to electrostatically charge the liquid sprayed by the handheld spray coating device.

6. The system of claim 4, wherein the conductive member is embedded in a groove along the interior surface of the non-conductive casing between the first end and the second end to electrostatically charge the liquid sprayed by the handheld spray coating device.

7. The system of claim 4, comprising a conductive casing coupled to the second end of the non-conductive casing, wherein the power supply couples to the conductive casing to electrostatically charge the liquid sprayed by the handheld spray coating device.

8. The system of claim 4, comprising a plurality of conductive members coupled to the power supply, wherein each conductive member of the plurality of conductive members couples to the non-conductive casing at a different position between the first end and the second end, and the power supply is configured to deliver different voltage levels to the plurality of conductive members.

9. The system of claim 4, wherein the conductive member extends circumferentially around an axis of the non-conductive casing along the interior surface between the first and second end of the non-conductive casing.

10. A system, comprising:
an indirect charging system configured to electrostatically charge a liquid sprayed from a handheld spray coating device with a rotary atomizer, wherein the indirect charging device system, comprises:
a non-conductive casing configured to couple to the handheld spray coating device; and
a power supply coupled to the non-conductive casing, wherein the power supply enables electrostatic charging of the liquid passing through the non-conductive casing.

11. The system of claim 10, wherein the non-conductive casing comprises an aperture with an interior surface between a first end and a second end.

12. The system of claim 11, wherein the non-conductive casing comprises an annular wall, a conical wall, a curved annular wall, a diverging wall, or any combination thereof.

13. The system of claim 11, wherein the non-conductive casing is offset from a bell cup of the rotary atomizer, wherein the bell cup is rotary and the non-conductive casing is stationary.

14. The system of claim 11, wherein the power supply couples to the non-conductive casing with a conductive member.

15. The system of claim 14, wherein the conductive member comprises a plurality of windings extending along an axis of the non-conductive casing, around the axis, or a combination thereof.

16. A system, comprising:
an electrostatic spray system, comprising:
a spray coating device;
an atomizer coupled to the spray coating device, wherein the atomizer is configured to atomize a liquid flowing through the spray coating device;
an indirect charging device, comprising:
a non-conductive casing downstream and radially offset from the atomizer; and
a power supply coupled to the non-conductive casing,
wherein the indirect charging device electrostatically charges the liquid exiting the atomizer.

17. The system of claim 16, wherein the atomizer comprises a rotary bell cup driven to rotate.

18. The system of claim 16, wherein the indirect charging device comprises a cascade voltage multiplier coupled to the power supply and configured to increase the voltage of the power supply.

19. The system of claim 16, wherein non-conductive casing comprises a stationary annular wall downstream from the atomizer.

20. The system of claim 16, wherein the power supply couples to the spray coating device.
